(19) United States
(12) Patent Application Publication
(10) Pub. No.: US 2012/0330510 A1
(43) Pub. Date: Dec. 27, 2012

(54) STEERING CONTROL SYSTEM

(75) Inventors: Hisashi KAWASE, Nishio-city (JP); Masashi HORI, Anjo-city (JP); Yasuhiko MUKAI, Anjo-city (JP)

(73) Assignees: NIPPON SOKEN, INC., Nishio-city (JP); DENSO CORPORATION, Kariya-city (JP)

(21) Appl. No.: 13/524,032

(22) Filed: Jun. 15, 2012

(30) Foreign Application Priority Data
Jun. 22, 2011 (JP) 2011-138166

(51) Int. Cl. B62D 6/08

(52) U.S. Cl. 701/41

(57) ABSTRACT

In a steering control system, an ECU calculates a basic assist torque in accordance with a steering torque detected by a torque sensor, and a corrected assist torque by correcting the calculated basic assist torque in accordance with the position of a rack by making corrections so that the basic assist torque decreases when the rack moves from a predetermined first position, which is close to a first end of a movable range, to the first end or from a predetermined second position, which is close to a second end of the movable range, to the second end. The ECU determines either the basic assist torque or the corrected assist torque as the assist torque in accordance with the position of the rack. The ECU controls the drive of an actuator in accordance with the determined assist torque.

### CROSS REFERENCE TO RELATED APPLICATION

This application is based on and incorporates herein by reference Japanese patent application No. 2011-138166 filed on Jun. 22, 2011.

### TECHNICAL FIELD

The present disclosure relates to a steering control system that controls the steering operation of a steering wheel of a vehicle.

### BACKGROUND ART

A conventional electric power steering system has a mechanism that generates torque with an electric actuator to assist a steering operation of a vehicle. A power steering control system disclosed, for instance, in JP H05-41466A (U.S. Pat. No. 4,708,220) includes a gear that engages with a rack for turning a steering wheel, drives the gear with an electric actuator to generate assist torque, and uses the generated assist torque to assist driver's steering of a steering member. The power steering control system calculates the assist torque in accordance with a vehicle speed detected by a vehicle speed sensor and a steering torque detected by a torque sensor. The power steering control system calculates the assist torque in such a manner that it increases with an increase in the steering torque and with a decrease in the vehicle speed. The power steering control system also provides increased vehicle travel stability in a high travel speed range by calculating the assist torque in such a manner that it decreases with a decrease in the steering torque and with an increase in the vehicle speed.

When the steering member continuously rotates in one direction due to the steering of the driver of the vehicle, the power steering control system allows, for instance, the end of the rack, which turns drive tire wheel (steered wheel), to collide, for instance, against the inner wall of a rack housing, which houses the rack. This stops not only the longitudinal movement of the rack but also the rotation of the steering member. The power steering control system performs calculations so that the assist torque increases in a low travel speed range where the travel speed of the vehicle is low. Therefore, when, for instance, the driver performs an abrupt steering operation particularly in the low travel speed range, the movement speed of the rack is high when it collides against the rack housing. As the energy of collision is proportional to the square of speed, it is anticipated that a high collision torque may be generated due to the collision between the rack and the rack housing.

In some cases, the peak value of collision torque may be more than ten times a normal steering torque. Therefore, when the rack collides against the rack housing, gears included in a steering force assist mechanism may be damaged by excessive impact. To avoid damage to the gears, it is necessary to set a high safety factor for the gears in consideration of the collision torque between the rack and the rack housing. When a high safety factor is set for the gears, the power steering control system may increase in physical size.

### SUMMARY

It is therefore an object to provide a compact, lightweight steering control system capable of preventing damage to structural members.

According to one aspect, a steering control system is mounted on a vehicle, which has an input shaft coupled to a steering member steered by a driver of the vehicle, an output shaft connected to the input shaft, a rack that reciprocates in a longitudinal direction when the output shaft rotates, a steered wheel that turns when the rack reciprocates, and a rack housing in which the rack is reciprocally housed. The steering control system comprises a steering force assist mechanism, a steering torque detection device, a basis assist torque calculation section, a corrected assist torque calculation section, an assist torque determination section and a drive control section.

The steering force assist mechanism includes a gear mechanism engaged with the output shaft or the rack and an actuator that drives the gear mechanism. The steering assist mechanism assists the steering of the steering member by using an assist torque that is generated when the actuator and the gear mechanism are driven. The steering torque detection device detects a steering torque that is input to the input shaft when the steering member is operated. The basic assist torque calculation section calculates a basic assist torque in accordance with the steering torque detected by the steering torque detection device. The corrected assist torque calculation section calculates a corrected assist torque by correcting the basic assist torque in accordance with a position of the rack. The assist torque determination section determines the assist torque based on either the basic assist torque or the corrected assist torque in accordance with the position of the rack. The drive control section controls the actuator in accordance with the assist torque determined by the assist torque determination section,

The corrected assist torque calculation section calculates the corrected assist torque by making corrections so that a value of the basic assist torque decreases when the rack moves from a predetermined first position, which is close to a first end of a movable range of the rack, to the first end, or from a predetermined second position, which is close to a second end of the movable range, to the second end, which is opposite to the first end. The assist torque determination section determines the basic assist torque as the assist torque when the rack is between the predetermined first position and the predetermined second position, and determines the corrected assist torque as the assist torque when the rack is between the predetermined first position and the first end or between the predetermined second position and the second end.

### BRIEF DESCRIPTION OF THE DRAWINGS

The above and other objects, features and advantages will become more apparent from the following detailed description made with reference to the accompanying drawings. In the drawings:

FIG. 1 is a schematic diagram illustrating a steering control system according to a first embodiment;

FIG. 2 is a flowchart illustrating a steering process performed by the steering control system according to the first embodiment;

FIG. 3 is a graph illustrating a correction factor that is used when a corrected assist torque calculation section of the steering control system according to the first embodiment calculates a corrected assist torque;

FIG. 4 is a time chart illustrating a collision torque exerted on the steering control system according to the first embodiment and a collision torque exerted on a comparative example of the steering control system;

FIG. 5 is a schematic diagram illustrating a steering control system according to a second embodiment;

FIG. 6 is a flowchart illustrating a steering process performed by the steering control system according to the second embodiment;

FIG. 7 is a schematic diagram illustrating a steering control system according to a third embodiment;

FIG. 8 is a flowchart illustrating a steering process performed by the steering control system according to the third embodiment;

FIG. 9 is a graph illustrating a correction factor that is used when the corrected assist torque calculation section of the steering control system according to the third embodiment calculates the corrected assist torque;

FIG. 10 is a schematic diagram illustrating a steering control system according to a fourth embodiment; and

FIG. 11 is a flowchart illustrating a steering process performed by the steering control system according to the fourth embodiment.

### DETAILED DESCRIPTION OF THE DISCLOSURE

A steering control system according to plural embodiments will now be described with reference to the accompanying drawings. In the description of the embodiments, substantially the same components or elements are designated by the same reference numerals for simplification of description.

### First Embodiment

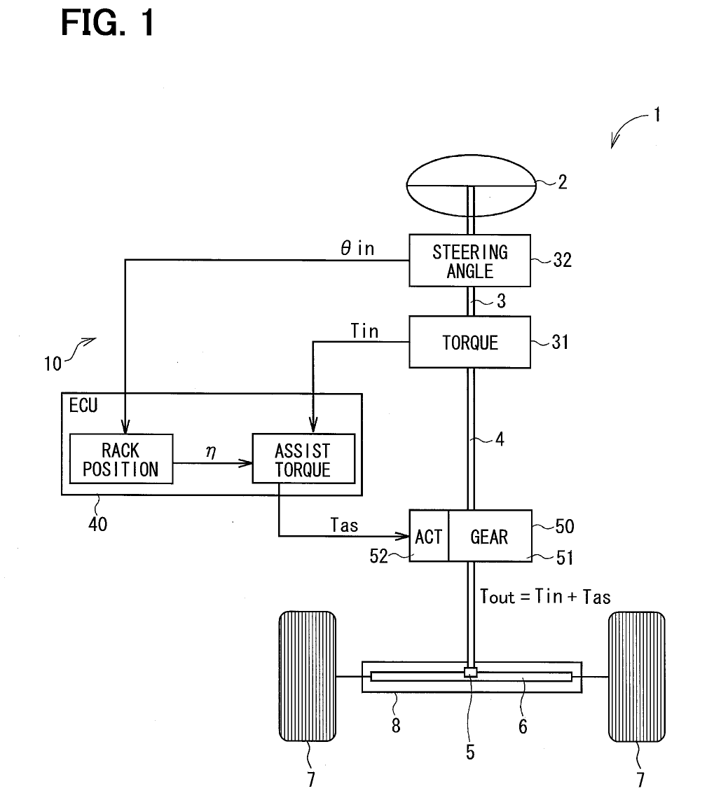

Referring first to FIG. 1, a steering control system 10 is applied to a vehicle 1 and used to control a vehicle steering operation performed by a driver of the vehicle.

The vehicle 1 includes, for example, a steering wheel 2, an input shaft 3, an output shaft 4, a rack 6, a steered wheel (drive tire wheel) 7, and a rack housing 8. The input shaft 3 is coupled to the steering wheel 2 that is steered by the driver. A rotation angle of the input shaft 3 that is formed when the steering wheel 2 is rotated for steering purposes is referred to as the steering angle.

The output shaft 4 is connected to the input shaft 3 by a torsion bar (not shown) in the conventional manner. The input shaft 3 and the output shaft 4 form a column shaft. A steering pinion 5 is disposed at an end of the output shaft 4 to engage with the rack 6. This ensures that the rack 6 reciprocates in a longitudinal direction of the rack 6 (lateral direction of the vehicle) when the output shaft 4 rotates. The rack 6 and the steering pinion 5 form a rack-and-pinion mechanism. The steered wheel 7 is disposed at both ends of the rack 6. This permits the steered wheel 7 to turn when the rack 6 reciprocates. The rotation angle of the output shaft 4 that is formed when the steered wheel 7 turns is referred to as the turning angle.

The rack 6 is reciprocatably housed in the rack housing 8. An end of the rack 6 abuts against the inner wall of the rack housing 8 to restrict a longitudinal reciprocating motion of the rack 6, that is, a stroke of the rack 6. That is, the rack 6 can reciprocate within a predetermined range (movable range) in the rack housing 8.

In the vehicle 1 to which the steering control system 10 is applied, the steering pinion 5 disposed at the end of the output shaft 4 engages with the front side of the rack 6 as viewed toward the rear of the vehicle 1. The rack 6 is connected to the steered wheel 7 at a point displaced rearward from the rotation center of the steered wheel 7 as viewed toward the rear of the vehicle 1. Therefore, when the driver rotates the steering wheel 2 (input shaft 3) clockwise (rightward) for steering purposes, the output shaft 4 rotates clockwise (rightward), thereby causing the rack 6 to move leftward as viewed toward the front of the vehicle 1. This changes the steered angle of the steered wheel 7 so as to move the vehicle 1 rightward (causes the steered wheel 7 to turn rightward). When, on the other hand, the driver rotates the steering wheel 2 (input shaft 3) counterclockwise (leftward), the output shaft 4 rotates counterclockwise (leftward), thereby causing the rack 6 to move rightward as viewed toward the front of the vehicle 1. This changes the steered angle of the steered wheel 7 so as to move the vehicle 1 leftward (causes the steered wheel 7 to turn leftward).

The steering control system 10 includes, for example, a steering force assist mechanism 50, which is formed of a gear mechanism 51 and an actuator 52, a torque sensor 31, and an electronic control unit (ECU) 40. The torque sensor 31 serves as a steering torque detection device.

The gear mechanism 51 is mounted on the output shaft 4. The gear mechanism 51 has a gear that engages with the output shaft 4.

The actuator 52 is an electric motor. The actuator 52 includes a worm gear that engages with external teeth formed on an outer end of the gear of the gear mechanism 51. The actuator 52 can rotationally drive the gear of the gear mechanism 51 by rotationally driving the worm gear.

When the actuator 52 is driven to rotate the gear of the gear mechanism 51, a torque generated by the rotation of the gear is applied to the output shaft 4. When the torque is applied from the actuator 52 through the gear mechanism 51 in the same direction as the rotation direction of the output shaft 4, which rotates when the driver rotates the steering wheel 2 for steering purposes, the applied torque assists the driver's steering operation of the steering wheel 2. That is, the torque applied to the output shaft 4 by driving the actuator 52 and the gear mechanism 51 turns out to be an assist torque that assists a steering force (steering torque) input from the driver to the steering wheel 2.

As described above, the first embodiment is configured so that the steering force assist mechanism 50 is formed by the gear mechanism 51 and the actuator 52. The steering force assist mechanism 50 assists the driver's steering of the steering wheel 2 by using the assist torque that is generated by driving the actuator 52 and the gear mechanism 51. The steering force assist mechanism 50 is a part of a column assist electric power steering system.

The torque sensor 31 is disposed between the input shaft 3 and the output shaft 4 to detect a steering torque that is input to the input shaft 3 when the driver steers the steering wheel 2. More specifically, the torque sensor 31 detects the steering torque by measuring the torsion angle of the torsion bar that connects the input shaft 3 to the output shaft 4.

The vehicle 1 includes a steering angle sensor 32 as well. The steering angle sensor 32 serves as a steering angle detection device. The steering angle sensor 32 is mounted on the input shaft 3 to detect the rotation angle of the input shaft 3, that is, the steering angle. The steering angle sensor 32 outputs a signal indicating the detected steering angle to the ECU 40.

The ECU 40 includes, for instance, a microcomputer having a computation section, such as a CPU, and storage sections, such as a RAM and a ROM. The ECU 40 is used to control various devices mounted on the vehicle 1 to which the steering control system 10 is applied. Signals output from the torque sensor 31, the steering angle sensor 32 and various other sensors disposed in various sections of the vehicle 1 are input into the ECU 40. The ECU 40 controls the various devices mounted on the vehicle 1 in accordance with the input signals and with a predetermined control program stored in the ROM.

The torque sensor 31 outputs a signal indicating the detected steering torque to the ECU 40. The ECU 40 is connected to the actuator 52 to control the rotational drive of the actuator 52 by adjusting electrical power supplied to the actuator 52. The ECU 40 can control the drive of the gear mechanism 51 by controlling the rotational drive of the actuator 52. Consequently, the ECU 40 can control the drive of the actuator 52 so that the assist torque takes a desired value.

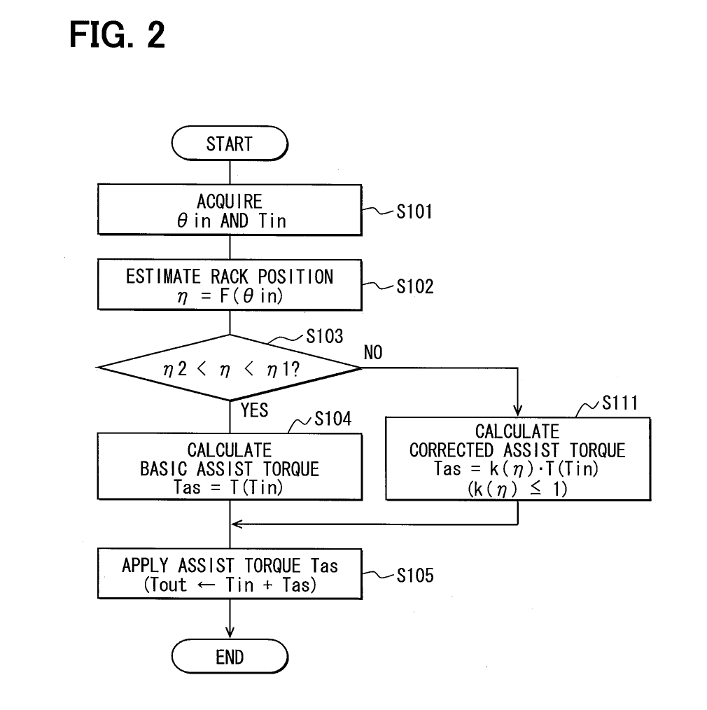

The ECU 40 is programmed to perform the control processing shown in FIG. 2 to control the operation of the steering control system 10 according to the first embodiment.

A series of processing steps shown in FIG. 2 is initiated when, for instance, the driver turns on an ignition key of the vehicle 1.

In step S101, the ECU 40 acquires various signals (information) from the sensors. The ECU 40 acquires specifically the steering torque Tin detected by the torque sensor 31. The ECU 40 also acquires the rotation angle of the input shaft 3 that is detected by the steering angle sensor 32, namely, the steering angle θin.

Upon completion of step S101, processing proceeds to step 5102. In step S102, the ECU 40 estimates the position of the rack 6. More specifically, the ECU 40 estimates the position of the rack 6 in accordance with the steering angle θin acquired in step S101. That is, the ECU 40 calculates the rack position q of the rack 6 by the following equation (1) in accordance with a function whose variable is θin (Equation 1 below) to estimate the position of the rack 6 that prevails in step S102.

η=F(θin) (1)

Here η is a value between −100 and 100 (%). It is assumed that the position η of the rack 6 is 0 (%) when the steering wheel 2, input shaft 3, output shaft 4, and steered wheel 7 are at the neutral position. It means that the rack 6 is positioned at the center of the movable range when η is 0.

When the steering wheel 2 is allowed to continuously rotate in one direction (e.g., clockwise), the rack 6 moves in one longitudinal direction so that its end abuts against the inner wall of the rack housing 8. This restricts the longitudinal movement of the rack 6, that is, the stroke of the rack 6. It is assumed that the prevailing position η of the rack 6 is 100 (%). More specifically, when η is 100, it means that the rack 6 is positioned at the first end of the movable range, namely, at the maximum stroke position (one limit position).

When the steering wheel 2 is allowed to continuously rotate in the other direction (e.g., counterclockwise), the rack 6 moves in the other longitudinal direction so that its end abuts against the inner wall of the rack housing 8. This restricts the longitudinal movement of the rack 6, that is, the stroke of the rack 6. It is assumed that the prevailing position η of the rack 6 is −100 (%). More specifically, when η is η100, it means that the rack 6 is positioned at the second end (second end) of the movable range, namely, at the maximum stroke position (the other limit position).

Upon completion of step S102, processing proceeds to step S103. In step S103, the ECU 40 checks whether the rack position η is between a first threshold value η1 and a second threshold value η2. It is assumed that the first threshold value is 90 while the second threshold value is −90. That is, the first threshold value corresponds to a position close to the first end of the movable range of the rack 6, namely, the first position. On the other hand, the second threshold value corresponds to a position close to the second end of the movable range of the rack 6, namely, the second position.

When the rack position η is determined to be between the first threshold value and the second threshold value, that is, when −90<η<90 (when the check result in step S103 is YES), processing proceeds to step S104. When, on the other hand, the rack position q is not determined to be between the first threshold value and the second threshold value, that is, when η≦−90 or 90≦η(when the check result in step S103 is NO), processing proceeds to step S111.

In step S104, the ECU 40 calculates a basic assist torque Tas. The basic assist torque is calculated in accordance with the steering torque Tin acquired in step S101. The basic assist torque is calculated by the following equation (2) in accordance with a function whose variable is Tin.

Tas=T(Tin) (2)

The ECU 40 then substitutes the calculated basic assist torque T(Tin) into the assist torque Tas. That is, the ECU 40 determines the basic assist torque T(Tin) as the assist torque Tas.

Upon completion of step S104, processing proceeds to step S105. In step S111, the ECU 40 calculates a corrected assist torque. The corrected assist torque is calculated by correcting the basic assist torque in accordance with the position η of the rack 6 that is estimated in step S102. More specifically, the corrected assist torque is calculated by multiplying the basic assist torque T(Tin) by a correction factor k(η) that is calculated in accordance with the position η of the rack 6.

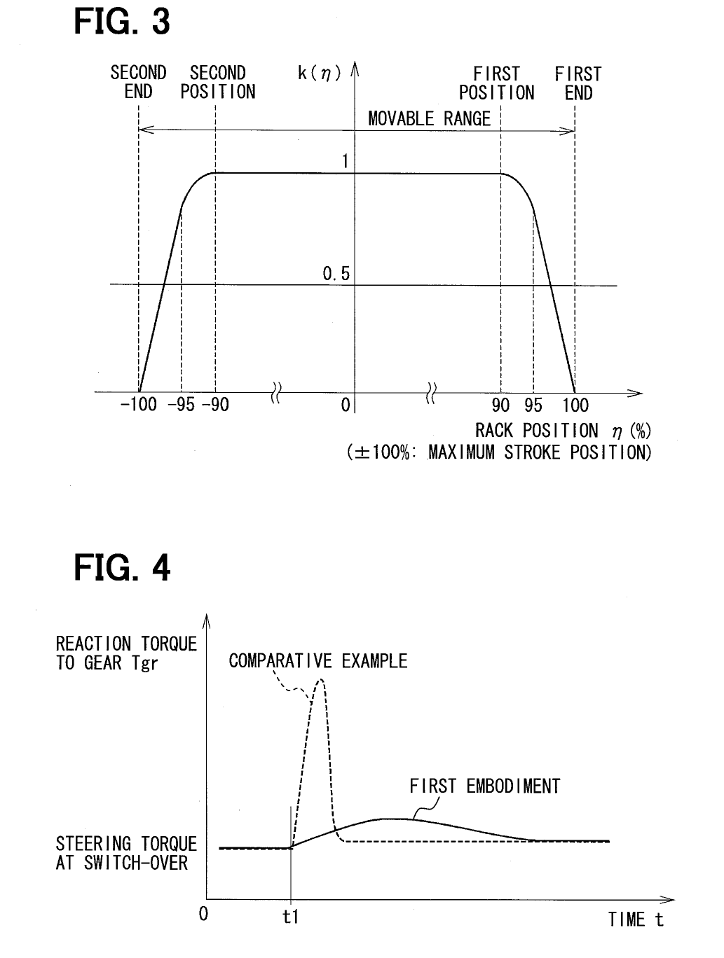

The correction factor k(η) is a value not greater than 1 and determined as a function of the rack position η as indicated in FIG. 3. As shown in FIG. 3, the correction factor k(η) is 1 when −90<η<90. When 90≦η≦100, that is, η changes from 90 to 100, the correction factor k(η) gradually decreases from1 to 0. Further, when −100≦η≦−90, that is, η changes from −90 to −100, the correction factor k(η) gradually decreases from 1 to 0. When η is 100 or −100, the correction factor k(η) is 0.

As shown in FIG. 3, when η changes from 90 to 95 or from −90 to −95, the correction factor k(η) decreases from 1 to 0.5 gradually non-linearly. When η changes from 95 to 100 or from −95 to −100, the correction factor k(η) decreases gradually linearly.

The basic assist torque T(Tin) is calculated as described in connection with step S104. The corrected assist torque is calculated by the following equation (3).

Tas=k(η)·T(Tin) (3)

That is, the calculated corrected assist torque k(η)·T(Tin) decreases when the rack 6 moves from the predetermined first position (90%) to the first end (100%) or from the predetermined second position (−90%) to the second end (−100%).

The ECU 40 then substitutes the calculated corrected assist torque k(η)×T(Tin) into the assist torque Tas. It means that the ECU 40 determines the corrected assist torque k(η)·T(Tin) as the assist torque Tas.

Upon completion of step S111, processing proceeds to step S105. In step S105, the ECU 40 sets the assist torque Tas determined in step S104 or S111 as the assist torque, and controls the drive of the actuator 52 so that the assist torque is applied to the output shaft 4. This ensures that the steering torque Tin and the assist torque Tas are both exerted on the output shaft 4. That is, a turning torque Tout, which is the sum of the steering torque Tin and the assist torque Tas, is exerted on the output shaft 4. As a result, the output shaft 4 rotates to move the rack 6 in a longitudinal direction, thereby turning the steered wheel 7.

Upon completion of step S105, processing finishes the series of processing steps shown in FIG. 2. Subsequently, when the ignition key is on, the ECU 40 resumes the series of processing steps shown in FIG. 2. That is, the series of processing steps shown in FIG. 2 is repeatedly performed when the ignition key is on.

As described above, in step S102, the ECU 40 functions as a rack position estimation section. In steps S103 and S104 and in steps S103 and S111, the ECU 40 functions as an assist torque determination section. In steps S104 and S111, the ECU 40 functions as a basic assist torque calculation section. In step S111, the ECU 40 functions as a corrected assist torque calculation section. In step S105, the ECU 40 functions as a drive control section.

As described above, the ECU 40 includes the rack position estimation section, the assist torque determination section, the basic assist torque calculation section, the corrected assist torque calculation section, and the drive control section as functional elements.

In the first embodiment, performing the above-described processing makes it possible to decrease the movement speed of the rack 6 when it collides against the rack housing 8. Thus, the collision energy between the rack 6 and the rack housing 8 can be reduced. As a result, when the rack 6 collides against the rack housing 8, the torque applied to the gear included in the gear mechanism 51 (collision torque Tgr) as a reaction can be reduced. This advantage will be described below in detail with reference to a comparative example (see FIG. 4).

The solid line in FIG. 4 indicates temporal changes in Tgr that occur when the steering wheel 2 is continuously rotated in one direction (dry-steered) while the vehicle 1 to which the steering control system 10 that performs the above-described series of processing steps is applied is stopped (vehicle speed V=0). The broken line in FIG. 4, on the other hand, indicates temporal changes in Tgr that occur when the steering wheel 2 is continuously rotated in one direction while the vehicle 1 to which a steering control system according to the comparative example is applied is stopped. Here, it is assumed that the steering control system according to the comparative example has the same hardware configuration as the steering control system 10 and performs the above-described steering processing steps except for steps S102, S103, and S111. That is, the steering control system according to the comparative example does not correct the basic assist torque.

As is obvious from FIG. 4, in a situation where the steering control system according to the comparative example is used, a high collision torque Tgr is applied to the gear in the gear mechanism 51 as the reaction torque (the peak value of the collision torque Tgr is great) when the rack 6 collides against the rack housing 8 at time t1. However, in a situation where the steering control system 10 according to the present embodiment is used, the peak value of the collision torque Tgr applied to the gear in the gear mechanism 51 is small even when the rack 6 collides against the rack housing 8 at time t1. As discussed above, the peak value of the collision torque generated when the rack 6 collides against the rack housing 8 is considerably smaller in the first embodiment than in the comparative example.

As described above, the ECU 40 (corrected assist torque calculation section) calculates the corrected assist torque by making corrections so that the basic assist torque decreases when the rack 6 moves from the predetermined first position (90%), which is close to a first end (one end, that is, 100%) of the movable range, to the predetermined second position (−90), which is close to a second end (the other end, that is −100) of the movable range, to the second end.

When the rack 6 is between the predetermined first position and the predetermined second position, the ECU 40 (assist torque determination section) determines the basic assist torque calculated by the basic assist torque calculation section as the assist torque. When, on the other hand, the rack 6 is between the predetermined first position and the first end or between the predetermined second position and the second end, the ECU 40 (assist torque determination section) determines the corrected assist torque calculated by the corrected assist torque calculation section as the assist torque.

In a situation where the rack 6 is positioned close to the first end or the second end of its movable range, the above-described configuration makes corrections so that the assist torque decreases when the driver steers the steering wheel 2 to move the rack 6 toward the first end or the second end of the movable range, that is, the rack 6 approaches the maximum stroke position. This decreases the movement speed of the rack 6 when it collides against the rack housing 8. As a result, the collision torque between the rack 6 and the rack housing 8 can be reduced. This makes it possible to set a low allowable torque for the gear mechanism 51 and reduce the size of the gear mechanism 51. Consequently, it is possible not only to decrease the physical size and weight of the steering control system 10, but also to reduce the cost of manufacturing the steering control system 10. Further, as the collision torque between the rack 6 and the rack housing 8 is reduced, damage to the gear mechanism 51 can be avoided to increase the reliability of the steering control system 10.

The first embodiment further includes the steering angle sensor 32 and the rack position estimation section. The steering angle sensor 32 detects the steering angle, which is the rotation angle of the input shaft 3. The ECU 40 (rack position estimation section) estimates the position of the rack 6 in accordance with the steering angle detected by the steering angle sensor 32.

The ECU 40 (corrected assist torque calculation section) corrects the basic assist torque in accordance with the position of the rack 6 that is estimated by the rack position estimation section. Further, the ECU 40 (assist torque determination section) determines the assist torque in accordance with the position of the rack 6 that is estimated by the rack position estimation section. As described above, the first embodiment does not use, for instance, a detection device that actually detects the position of the rack 6, but uses the ECU 40 (rack position estimation section) to estimate the position of the rack 6 and allows the corrected assist torque calculation section to correct the basic assist torque. This makes it possible to decrease the number of employed members.

### Second Embodiment

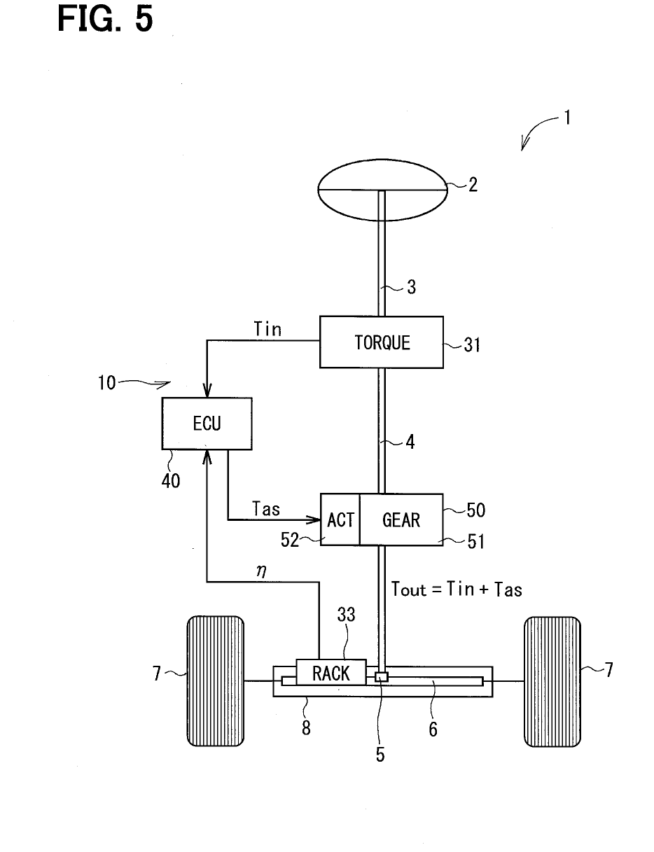

A steering control system 10 according to a second embodiment is shown in FIG. 5. The second embodiment differs from the first embodiment in configuration and partly differs from the first embodiment in steering-related processing.

As compared to the first embodiment, the second embodiment does not include the steering angle sensor 32, but instead includes a rack position sensor 33, which serves as a rack position detection device. The rack position sensor 33 is mounted in the rack housing 8 to detect the position of the rack 6. The rack position sensor 33 outputs a signal indicating the detected position of the rack 6 to the ECU 40. The signal (η) output from the rack position sensor 33 corresponds to a value between −100 and 100 (%).

When the steering wheel 2, the input shaft 3, the output shaft 4, and the steered wheel 7 are at the neutral position, the signal (η) output from the rack position sensor 33 is 0 (%). When q is 0, the rack 6 is positioned at the center of its movable range.

When the steering wheel 2 is continuously rotated in one direction (e.g., clockwise) until the end of the rack 6 abut against the inner wall of the rack housing 8, the signal (η) output from the rack position sensor 33 is 100 (%). When η is 100, the rack 6 is positioned at the first end of its movable range, namely, at the maximum stroke position.

When the steering wheel 2 is continuously rotated in the other direction (e.g., counterclockwise) until the end of the rack 6 abut against the inner wall of the rack housing 8, the signal (η) output from the rack position sensor 33 is −100 (%). When η is −100, the rack 6 is positioned at the second end of its movable range, namely, at the maximum stroke position.

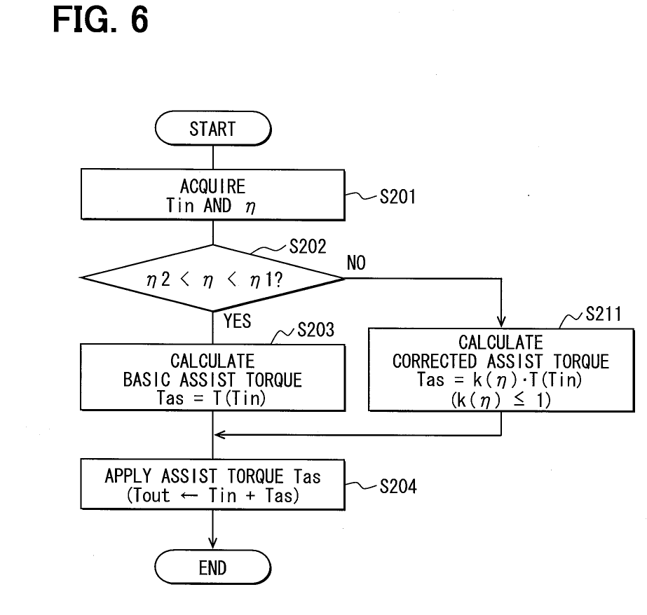

The ECU 40 of the steering control system according to the second embodiment is programmed to perform the control processing shown in FIG. 6. The series of processing steps is initiated when, for instance, the driver turns on the ignition key of the vehicle 1.

In step S201, the ECU 40 acquires various signals (information) from the sensors. The ECU 40 acquires the steering torque Tin detected by the torque sensor 31. The ECU 40 also acquires the rack position η detected by the rack position sensor 33.

Upon completion of step S201, processing proceeds to step S202. In step S202, the ECU 40 checks whether the rack position q acquired in step S201 is between the first threshold value η1 and the second threshold value η2. It is assumed that the first threshold value is 90 while the second threshold value is -90, as is the case with step S103, which is performed in the first embodiment. Step S202 differs from step S103, which is performed in the first embodiment, in that the rack position q used in step S103 is estimated by the ECU 40 (rack position estimation section) whereas the actual rack position η used in step S202 is detected by the rack position sensor 33.

When the rack position η is determined to be between the first threshold value and the second threshold value, that is, when −90<η<90 (when the check result in step S202 is YES), processing proceeds to step S203. When, on the other hand, the rack position η is not determined to be between the first threshold value and the second threshold value, that is, when η≦−90 or 90≦η (when the check result in step S202 is NO), processing proceeds to step S211.

In step S203, the ECU 40 calculates the basic assist torque. The basic assist torque is calculated in accordance with the steering torque Tin acquired in step S201. The basic assist torque is calculated as described in connection with step S104, which is performed in the first embodiment. The ECU 40 determines the calculated basic assist torque T(Tin) as the assist torque Tas.

Upon completion of step S203, processing proceeds to step S204. In step S211, the ECU 40 calculates the corrected assist torque. The corrected assist torque is calculated by correcting the basic assist torque in accordance with the position of the rack 6, that is, the rack position q acquired in step S201. The corrected assist torque is calculated as described in connection with step S111, which is performed in the first embodiment. Step 5211 differs from step S111 in that the rack position η used in step S111 is estimated by the ECU 40 (rack position estimation section) whereas the rack position rᵢ used in step S211 is detected by the rack position sensor 33. The ECU 40 determines the calculated corrected assist torque k(η)·T(Tin) as the assist torque Tas.

Upon completion of S211, processing proceeds to step S204. In step S204, the ECU 40 sets the assist torque Tas determined in step S203 or S211 as the assist torque, and controls the drive of the actuator 52 of the steering force assist mechanism 50 so as to obtain the assist torque.

Upon completion of step S204, the ECU 40 finishes the series of processing steps. Subsequently, when the ignition key is on, the ECU 40 resumes the series of processing steps shown in FIG. 6. That is, the series of processing steps in FIG. 6 is repeatedly performed when the ignition key is on.

As described above, in steps S202 and S203 and in steps S202 and S211, the ECU 40 functions as the assist torque determination section. In steps S203 and S211, the ECU 40 functions as the basic assist torque calculation section. In step S211, the ECU 40 functions as the corrected assist torque calculation section. In step S204, the ECU 40 functions as the drive control section.

As described above, the ECU 40 in the second embodiment includes the assist torque determination section, the basic assist torque calculation section, the corrected assist torque calculation section, and the drive control section as functional elements.

In the second embodiment, performing the above-described processing makes it possible to decrease the movement speed of the rack 6 when it collides against the rack housing 8, as is the case with the first embodiment. Thus, the collision energy between the rack 6 and the rack housing 8 can be reduced. As a result, when the rack 6 collides against the rack housing 8, the torque applied to the gear included in the gear mechanism 51 (collision torque Tgr) as the reaction torque can be reduced.

As described above, the second embodiment includes the rack position sensor 33, which detects the position of the rack 6. The ECU 40 (corrected assist torque calculation section) corrects the basic assist torque in accordance with the position of the rack 6 that is detected by the rack position sensor 33. Further, the ECU 40 (assist torque determination section) determines the assist torque in accordance with the position of the rack 6 that is detected by the rack position sensor 33. As described above, the second embodiment can accurately detect the position of the rack 6 by using the rack position sensor 33 that actually detects the position of the rack 6. Therefore, the second embodiment enables the ECU 40 (corrected assist torque calculation section) to correct the basic assist torque with increased accuracy.

### Third Embodiment

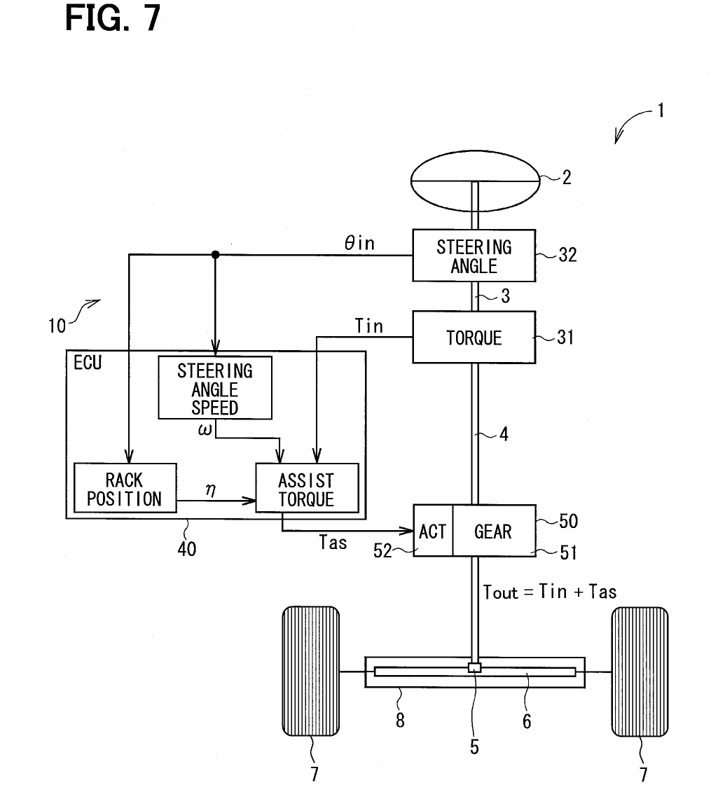

A steering control system 10 according to a third embodiment is shown in FIG. 7. The third embodiment has the same configuration as the first embodiment, but partly differs from the first embodiment in steering-related processing.

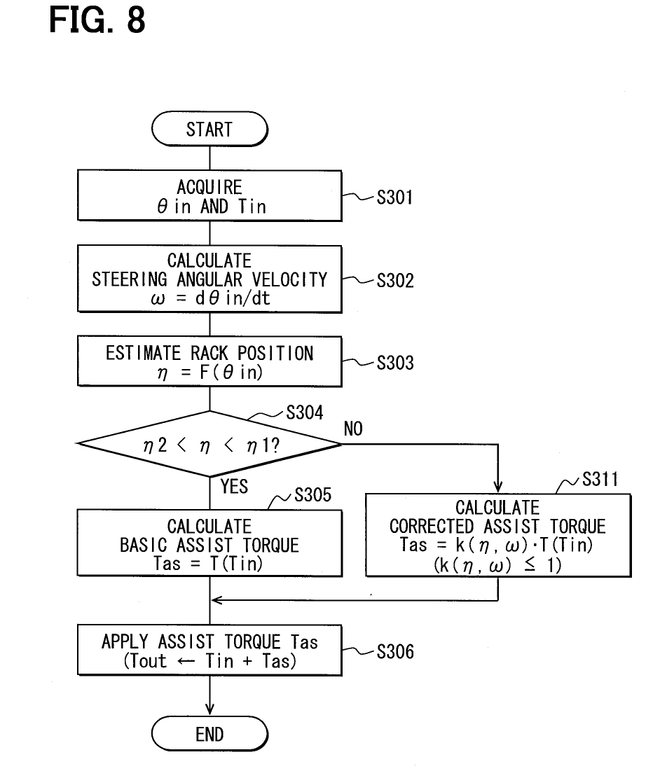

The ECU 40 is programmed to perform control processing as shown in FIG. 8. A series of processing steps shown in FIG. 8 is initiated when, for instance, the driver turns on the ignition key of the vehicle 1.

In step S301, the ECU 40 acquires various signals (information) from the sensors. The ECU 40 acquires the steering torque Tin detected by the torque sensor 31. The ECU 40 also acquires the rotation angle of the input shaft 3 that is detected by the steering angle sensor 32, namely, the steering angle θin.

Upon completion of step S301, processing proceeds to step S302. In step S302, the ECU 40 calculates a steering angular velocity, which is the angular velocity of the input shaft 3. More specifically, the ECU 40 calculates the steering angular velocity in accordance with the steering angle θin acquired in step S301. That is, the ECU 40 calculates the steering angular velocity ω by subjecting the steering angle bin to mathematical differentiation as indicated in the following equation (4).

ω=dνin/dt (4)

Upon completion of step S302, processing proceeds to step S303. In step S303, the ECU 40 estimates the position of the rack 6. More specifically, the ECU 40 estimates the position of the rack 6 in accordance with the steering angle θin acquired in step S301. The position of the rack 6 is estimated as described in connection with step S102, which is performed in the first embodiment.

Upon completion of step S303, processing proceeds to step S304. In step S304, the ECU 40 checks whether the rack position q is between the first threshold value η1 and the second threshold value η2. It is assumed that the first threshold value is 90 while the second threshold value is −90, as is the case with step S103, which is performed in the first embodiment.

When the rack position n is determined to be between the first threshold value and the second threshold value, that is, when −90<η<90 (when the check result in step S304 is YES), processing proceeds to step S305. When, on the other hand, the rack position η is not determined to be between the first threshold value and the second threshold value, that is, when η≦−90 or 90≦η (when the check result in step S304 is NO), processing proceeds to step S311.

In step S305, the ECU 40 calculates the basic assist torque. The basic assist torque is calculated in accordance with the steering torque Tin acquired in step S301. The basic assist torque is calculated as described in connection with step S104, which is performed in the first embodiment. The ECU 40 determines the calculated basic assist torque T(Tin) as the assist torque Tas.

Upon completion of step S305, processing proceeds to step S306. In step S311, the ECU 40 calculates the corrected assist torque. The corrected assist torque is calculated by correcting the basic assist torque in accordance with the position of the rack 6, namely, the position of the rack 6 that is estimated in step S303, and with the steering angular velocity ω calculated in step S302. More specifically, the corrected assist torque is calculated by multiplying the basic assist torque T(Tin) by a correction factor k(η, ω) that is calculated in accordance with the position η of the rack 6 and with the steering angular velocity ω.

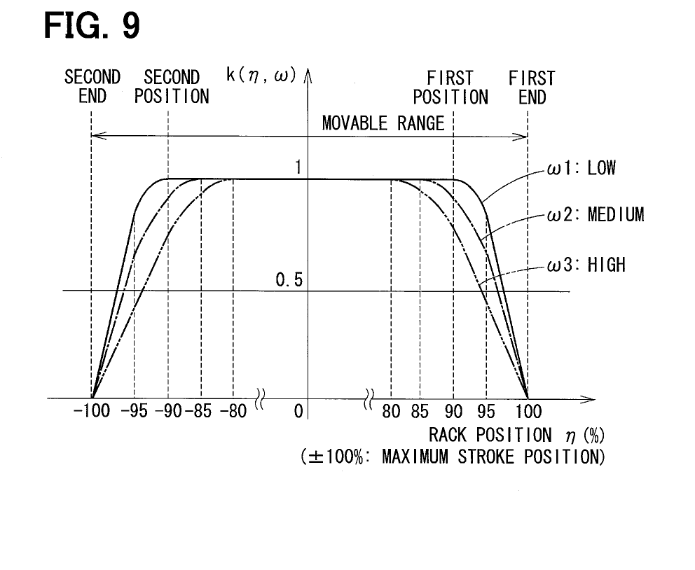

The correction factor k(η, ω) is a value not greater than 1. The relationship between the correction factor k(η, ω) and rack position η is as indicated in FIG. 9. The correction factor k(η, ω) is determined as a function of the rack position η and the steering wheel angular velocity ω. The values ω₁, ω₂, and ω₃ of the angular velocity ω are respectively within a predetermined range and ω₁<ω₂<ω₃. When ω is ω₁, it means that the rotation speed of the steering wheel 2, that is, the speed of steering rotation is in a low speed range. When ω is ω₂, it means that the speed of steering rotation is in a medium-speed range. When ω is ω₃, it means that the speed of steering rotation is in a high-speed range.

As shown in FIG. 9, the correction factor k(η, ω₁) is 1 when −90<η<90. When 90≦η≦100 and η changes from 90 to 100, the correction factor k(η, ω₁) gradually decreases from 1 to 0.Further, when −100≦η≦−90 and η changes from −90 to −100, the correction factor k(η, ω₁) gradually decreases from 1 to 0. When η is 100 or −100, the correction factor k(η, ω₁) is 0. When ω is ω₁, the predetermined first position and the first threshold value are 90, whereas the predetermined second position and the second threshold value are −90.

As shown in FIG. 9, when η changes from 90 to 95 or from −90 to −95, the correction factor k(η, ω₁) decreases gradually in a curved or nonlinear manner. Further, when η changes from 95 to 100 or from −95 to −100, the correction factor k(η, ω₁) decreases gradually in a linear manner.

The correction factor k(η, ω₂) is 1 when −85<η<85. When 85≦η≦100 and η changes from 85 to 100, the correction factor k(η, ω₂) gradually decreases from 1 to 0. Further, when −100≦η≦−85 and η changes from −85 to −100, the correction factor k(η, ω₂) gradually decreases from 1 to 0. When q is 100 or −100, the correction factor k(η, ω₂) is 0. When ω is ω₂, the predetermined first position and the first threshold value are 85, whereas the predetermined second position and the second threshold value are −85.

As shown in FIG. 9, when η changes from 85 to 95 or from −85 to −95, the correction factor k(η, ω₂) decreases gradually in a curved manner. Further, when η changes from 95 to 100 or from −95 to −100, the correction factor k(η, ω₂) decreases gradually in a linear manner.

The correction factor k(η, ω₃) is 1 when −80<η<80. When 80≦η≦100 and η changes from 80 to 100, the correction factor k(η, ω₃) gradually decreases from 1 to 0. Further, when −100≦η≦−80 and η changes from −80 to −100, the correction factor k(η, ω₃) gradually decreases from 1 to 0. When η is 100 or −100, the correction factor k(η, ω₃) is 0. When ω is ω₃, the predetermined first position and the first threshold value are 80, whereas the predetermined second position and the second threshold value are −80.

As shown in FIG. 9, when η changes from 80 to 90 or from −80 to −90, the correction factor k(η, ω₃) used in the third embodiment decreases gradually in a curved manner. Further, when η changes from 90 to 100 or from −90 to −100, the correction factor k(η, ω₃) decreases gradually in a linear manner.

As described above, when ω is ω₂ or ω₃, that is, when the angular velocity of steering rotation is in the medium or high speed range, the predetermined first position and the first threshold value are changed from 90 to 85 or 80 and the predetermined second position and the second threshold value are changed from −90 to −85 or −80. Changes in the first and the second threshold values affect the determination formulated by the ECU 40 in step S304. In reality, it is assumed that the first and the second threshold values on which the determination formulated in step S304 is based are 90 and −90, respectively, when the steering angular velocity ω calculated in step S302 is ω₁, 85 and −85, respectively, when the steering angular velocity ω calculated in step S302 is ω₂, and 80 and −80, respectively, when the steering angular velocity ω calculated in step S302 is ω₃.

The basic assist torque T(Tin) is calculated as described in connection with step S305. The corrected assist torque is calculated by the following equation (5).

Tas=k(η, ω)·T(Tin) (5)

That is, the calculated corrected assist torque k(η, ω)·T(Tin) decreases when the rack 6 moves from the predetermined first position (90%, 85%, or 80%) to the first end (100%) or from the predetermined second position (−90%, −85%, or −80%) to the second end (−100%).

The ECU 40 then substitutes the calculated corrected assist torque k(η, ω)×T(Tin) into the assist torque Tas. It means that the ECU 40 determines the corrected assist torque k(η, ω)·T(Tin) as the assist torque Tas.

Upon completion of step S311, processing proceeds to step S306. In step S306, the ECU 40 sets the assist torque Tas determined in step S305 or S311 as the assist torque, and controls the drive of the actuator 52 of the steering force assist mechanism 50 so as to obtain the assist torque.

Upon completion of step S306, the ECU 40 finishes the series of processing steps shown in FIG. 8. Subsequently, when the ignition key is on, the ECU 40 resumes the series of processing steps shown in FIG. 8. That is, the series of processing steps in FIG. 8 is repeatedly performed when the ignition key is on.

As described above, in step S302, the ECU 40 functions as the steering angular velocity calculation section. In step S303, the ECU 40 functions as the rack position estimation section. In steps S304 and S305 and in steps S304 and S311, the ECU 40 functions as the assist torque determination section. In steps S305 and S311, the ECU 40 functions as the basic assist torque calculation section. In step S311, the ECU 40 functions as the corrected assist torque calculation section. In step S306, the ECU 40 functions as the drive control section.

As described above, the ECU 40 in the third embodiment includes the steering angular velocity calculation section, the rack position estimation section, the assist torque determination section, the basic assist torque calculation section, the corrected assist torque calculation section, and the drive control section as functional elements.

In the third embodiment, performing the above-described processing makes it possible to decrease the movement speed of the rack 6 when it collides against the rack housing 8, as is the case with the first embodiment. Thus, the collision energy between the rack 6 and the rack housing 8 can be reduced. As a result, when the rack 6 collides against the rack housing 8, the torque applied to the gear included in the gear mechanism 51 (collision torque Tgr) as a reaction can be reduced.

The ECU 40 selects a correction factor k(η, ω) and corrects the basic assist torque T(Tin) in step S311 in accordance with the steering angular velocity (ω₁, ω₂, or ω₃ where ω₁<ω₂<ω₃) calculated in step S302. Hence, the assist torque is corrected in a map-like manner in accordance with the steering angular velocity. For example, the degree of assist torque correction increases when the steering angular velocity ω is high (e.g., ω=ω₃) and decreases when the steering angular velocity ω is low (e.g., ω=ω₁).

As described above, the present embodiment further includes the steering angular velocity calculation section, which calculates the steering angular velocity, namely, the angular velocity of the input shaft 3, in accordance with the steering angle detected by the steering angle sensor 32.

The ECU 40 (corrected assist torque calculation section) corrects the basic assist torque in accordance with the position of the rack 6 and with the steering angular velocity calculated by the steering angular velocity calculation section. Further, the ECU 40 (assist torque determination section) determines the assist torque in accordance with the position of the rack 6 and with the steering angular velocity calculated by the steering angular velocity calculation section.

The third embodiment corrects the assist torque in accordance with the steering angular velocity, for instance, by increasing the degree of assist torque correction when the steering angular velocity is high and by decreasing the degree of assist torque correction when the steering angular velocity is low. That is, the basic assist torque is corrected to decrease as the steering angular velocity increases. The predetermined first position and the predetermined second position are preferably decreased as the steering angular velocity increases. This makes it possible not only to effectively decrease the collision torque between the rack 6 and the rack housing 8, but also to reduce the degree of discomfort that may be given to the driver due to the correction made by the present embodiment, which makes corrections so as to decrease the assist torque in the vicinity of the maximum stroke position.

### Fourth Embodiment

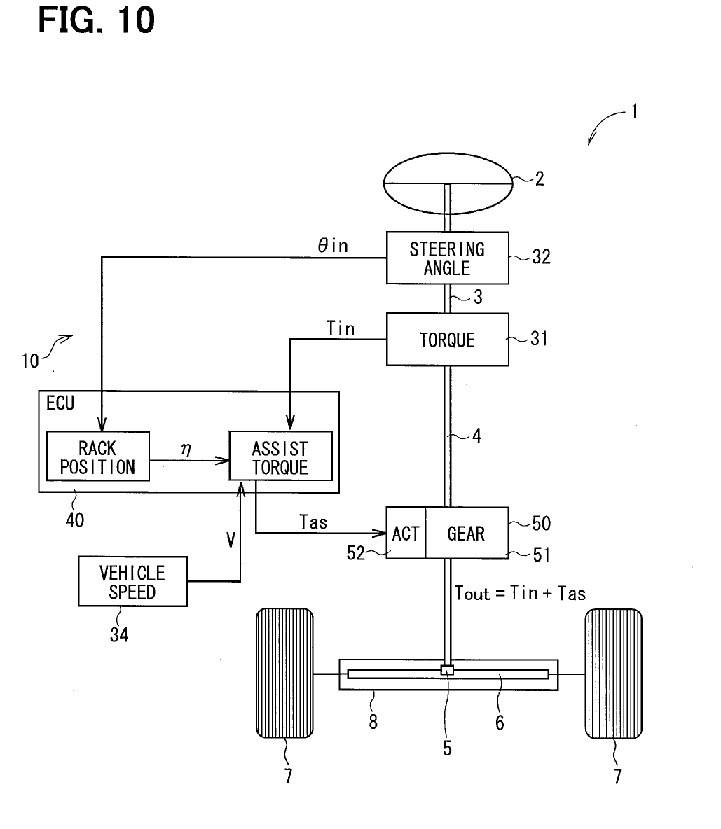

A steering control system 10 according to a fourth embodiment is shown in FIG. 10. The fourth embodiment differs from the first embodiment in hardware configuration, and partly differs from the first embodiment in steering-related processing.

The fourth embodiment includes a vehicle speed sensor 34 as a speed detection device. The vehicle speed sensor 34 is mounted on the vehicle 1 to detect the speed of the vehicle, that is, the vehicle speed. The vehicle speed sensor 34 outputs a signal indicating the detected vehicle speed V to the ECU 40.

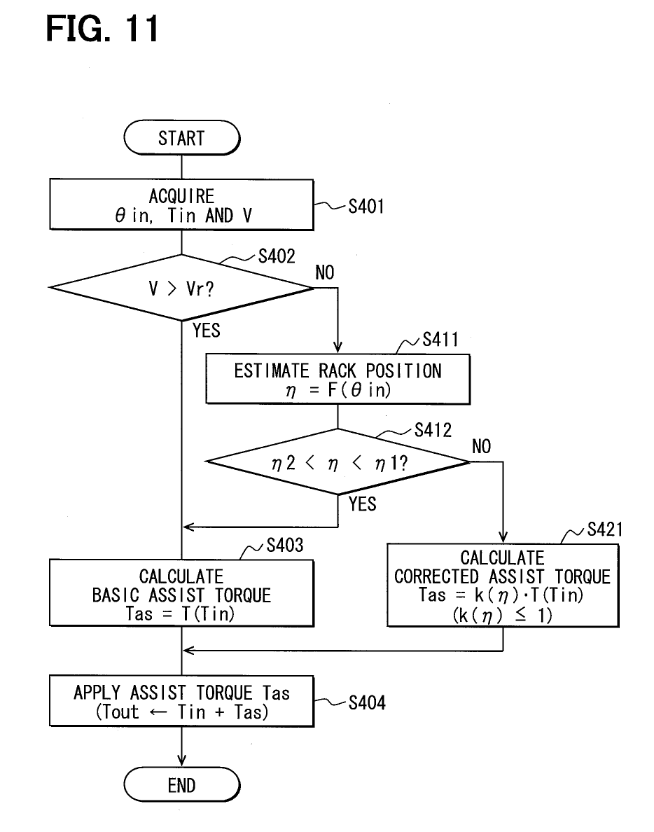

The ECU 40 is programmed to perform control processing as shown in FIG. 11. A series of processing steps in FIG. 11 is initiated when, for instance, the driver turns on the ignition key of the vehicle 1.

In step S401, the ECU 40 acquires various signals (information) from the sensors. The ECU 40 acquires the steering torque Tin detected by the torque sensor 31. The ECU 40 also acquires the rotation angle of the input shaft 3 that is detected by the steering angle sensor 32, namely, the steering angle θin. The ECU 40 also acquires the vehicle speed V detected by the vehicle speed sensor 34.

Upon completion of step S401, processing proceeds to step S402. In step S402, the ECU 40 checks whether the value of the vehicle speed V acquired in step S401 is greater than a predetermined threshold value Vr. The predetermined threshold value Vr is relatively small. When the value of the vehicle speed V is determined to be greater than the predetermined threshold value Vr (when the check result in step S402 is YES), processing proceeds to step S403. When, on the other hand, the value of the vehicle speed V is not determined to be greater than the predetermined threshold value Vr, that is, when the value of the vehicle speed V is not greater than the predetermined threshold value Vr (when the check result in step S402 is NO), processing proceeds to step S411.

In step S411, the ECU 40 estimates the position of the rack 6. More specifically, the ECU 40 estimates the position of the rack 6 in accordance with the steering angle θin acquired in step S401. The position of the rack 6 is estimated as described in connection with step S102, which is performed in the first embodiment.

Upon completion of step S411, processing proceeds to step S412. In step S412, the ECU 40 checks whether the rack position η is between the first threshold value η1 and the second threshold value η2. It is assumed that the first threshold value is 90 while the second threshold value is −90, as is the case with step S103, which is performed in the first embodiment.

When the rack position η is determined to be between the first threshold value and the second threshold value, that is, when −90<θ<90 (when the check result in step S412 is YES), processing proceeds to step S403. When, on the other hand, the rack position η is not determined to be between the first threshold value and the second threshold value, that is, when or η≦−90 or 90≦η (when the check result in step S412 is NO), processing proceeds to step S421.

In step S403, the ECU 40 calculates the basic assist torque. The basic assist torque is calculated in accordance with the steering torque Tin acquired in step S401. The basic assist torque is calculated as described in connection with step S104, which is performed in the first embodiment. The ECU 40 determines the calculated basic assist torque T(Tin) as the assist torque Tas.

Upon completion of step S403, processing proceeds to step S404. In step S421, the ECU 40 calculates the corrected assist torque. The corrected assist torque is calculated by correcting the basic assist torque in accordance with the position of the rack 6, namely, the rack position η estimated in step S411. The corrected assist torque is calculated as described in connection with step S111, which is performed in the first embodiment. The ECU 40 determines the calculated corrected assist torque k(η)·T(Tin) as the assist torque Tas.

Upon completion of step S421, processing proceeds to step S404. In step S404, the ECU 40 sets the assist torque Tas determined in step S403 or S421 as the assist torque, and controls the drive of the actuator 52 of the steering force assist mechanism 50 so as to obtain the assist torque.

Upon completion of step S404, processing finishes the series of processing steps shown in FIG. 11. Subsequently, when the ignition key is on, the ECU 40 resumes the series of processing steps shown in FIG. 11. That is, the series of processing steps shown in FIG. 11 is repeatedly performed when the ignition key is on.

As described above, in step S411, the ECU 40 functions as the rack position estimation section. In steps S402, S412, and S403 and in steps S402, S412, and S421, the ECU 40 functions as the assist torque determination section. In steps S403 and S421, the ECU 40 functions as the basic assist torque calculation section. In steps S402 and S421, the ECU 40 functions as the corrected assist torque calculation section. In step S404, the ECU 40 functions as the drive control section.

As described above, the ECU 40 in the fourth embodiment includes the rack position estimation section, the assist torque determination section, the basic assist torque calculation section, the corrected assist torque calculation section, and the drive control section as functional elements.

In the fourth embodiment, performing the above-described processing makes it possible to decrease the movement speed of the rack 6 when it collides against the rack housing 8, as is the case with the first embodiment. Thus, the collision energy between the rack 6 and the rack housing 8 can be reduced. As a result, when the rack 6 collides against the rack housing 8, the torque applied to the gear included in the gear mechanism 51 (collision torque Tgr) as a reaction can be reduced.

In accordance with the value of the vehicle speed V acquired in step S401, the ECU 40 checks whether the basic assist torque is to be corrected in step 5402. When the vehicle speed V acquired in step S401 is not higher than the predetermined threshold value, that is, when the vehicle 1 is traveling at a low travel speed, the basic assist torque is corrected in accordance with the position of the rack 6 (step S421). When, on the other hand, the vehicle 1 is traveling at a medium speed or at a high speed, the basic assist torque is not corrected (step S403).

As described above, the fourth embodiment includes the vehicle speed sensor 34, which detects the speed of the vehicle 1. The ECU 40 (corrected assist torque calculation section) corrects the basic assist torque in accordance with the position of the rack 6 and with the speed of the vehicle 1 that is detected by the vehicle speed sensor 34. Further, the ECU 40 (assist torque determination section) determines the assist torque in accordance with the position of the rack 6 and with the speed of the vehicle 1 that is detected by the vehicle speed sensor 34.

When the speed of the vehicle 1 is high, the present embodiment does not calculate the corrected assist torque with the corrected assist torque calculation section. The fourth embodiment calculates the corrected assist torque with the corrected assist torque calculation section only when the speed of the vehicle 1 is low. This makes it possible to correct the assist torque only when the vehicle 1 is traveling at a low travel speed at which the rack 6 is likely to collide against the rack housing 8 due to an abrupt steering operation in an actual driving scene.

### Other Embodiments

Hardware configurations and functional configurations of the foregoing embodiments may be combined in any combination as far as there are no configuration-related impediments.

It is assumed in the third embodiment that the assist torque is corrected in a map-like manner in accordance with the steering angular velocity w. For example, the degree of assist torque correction increases when the steering angular velocity ω is high (e.g., ω=ω₃) and decreases when the steering angular velocity ω is low (e.g., ω=ω₁). However, it is possible to calculate the corrected assist torque by using a correction factor that includes a function (f(ω)) whose variable is w, such as f(ω)·k(η). An alternative is to calculate the corrected assist torque by using a correction factor that is obtained by adding or subtracting a function (f(ω)) whose variable is w, such as k(η)±f(ω).

It is assumed in the foregoing embodiments that a column assist electric power steering mechanism is employed to apply the assist torque to the output shaft with the gear mechanism engaged with the output shaft. However, it is possible that a rack assist electric power steering mechanism is employed to apply the assist torque to the rack with the gear mechanism engaged with the rack.

The foregoing embodiments have been described on the assumption that an electric motor is employed as the actuator. However, another embodiment of the present disclosure may be configured so that a motive power source other than an electric motor is employed as the actuator as far as the drive of the actuator can be controlled as desired.

It is also possible to further include a variable transfer ratio mechanism that changes a transfer ratio, which is the ratio between the rotation angle of the output shaft, namely, the turning angle, and the rotation angle of the input shaft, namely, the steering angle.

It is noted that a power steering system is not limited to the above-described embodiments but may be implemented in different embodiments.

What is claimed is:

1. A steering control system mounted on a vehicle having an input shaft coupled to a steering member steered by a driver of the vehicle, an output shaft connected to the input shaft, a rack that reciprocates in a longitudinal direction when the output shaft rotates, a steered wheel that turns when the rack reciprocates, and a rack housing in which the rack is reciprocatably housed, the steering control system comprising:
a steering force assist mechanism including a gear mechanism engaged with the output shaft or the rack and an actuator that drives the gear mechanism, the steering assist mechanism assisting the steering of the steering member by using an assist torque that is generated when the actuator and the gear mechanism are driven;
a steering torque detection device that detects a steering torque that is input to the input shaft when the steering member is operated;
a basic assist torque calculation section that calculates a basic assist torque in accordance with the steering torque detected by the steering torque detection device;
a corrected assist torque calculation section that calculates a corrected assist torque by correcting the basic assist torque in accordance with a position of the rack;
an assist torque determination section that determines the assist torque based on either the basic assist torque or the corrected assist torque in accordance with the position of the rack; and
a drive control section that controls the actuator in accordance with the assist torque determined by the assist torque determination section,
wherein the corrected assist torque calculation section calculates the corrected assist torque by making corrections so that a value of the basic assist torque decreases when the rack moves from a predetermined first position, which is close to a first end of a movable range of the rack, to the first end, or from a predetermined second position, which is close to a second end of the movable range, to the second end, which is opposite to the first end, and
wherein the assist torque determination section determines the basic assist torque as the assist torque when the rack is between the predetermined first position and the predetermined second position, and determines the corrected assist torque as the assist torque when the rack is between the predetermined first position and the first end or between the predetermined second position and the second end.

2. The steering control system according to claim 1, further comprising:
a steering angle detection device that detects a steering angle, which is a rotation angle of the input shaft; and
a rack position estimation section that estimates a position of the rack in accordance with the steering angle detected by the steering angle detection device,
wherein the corrected assist torque calculation section corrects the basic assist torque in accordance with the position of the rack that is estimated by the rack position estimation section.

3. The steering control system according to claim 1, further comprising:
a rack position detection device that detects the position of the rack,
wherein the corrected assist torque calculation section corrects the basic assist torque in accordance with the position of the rack that is detected by the rack position detection device.

4. The steering control system according to claim 2, further comprising:
a steering angular velocity calculation section that calculates a steering angular velocity, which is the angular velocity of the input shaft, in accordance with the steering angle detected by the steering angle detection device,
wherein the corrected assist torque calculation section corrects the basic assist torque in accordance with the position of the rack and with the steering angular velocity calculated by the steering angular velocity calculation section.

5. The steering control system according to claim 4,
wherein the corrected assist torque calculation section corrects the basic assist torque to be lower as the steering angular velocity increases.

6. The steering control system according to claim 4,
wherein the predetermined first position and the predetermined second position is decreased as the steering angular velocity increases.

7. The steering control system according to claim 2, further comprising:
a speed detection device that detects the speed of the vehicle,
wherein the corrected assist torque calculation section corrects the basic assist torque in accordance with the position of the rack and with the speed of the vehicle that is detected by the speed detection device.
